(19) United States
(12) Patent Application Publication
(10) Pub. No.: US 2015/0234731 A1
(43) Pub. Date: Aug. 20, 2015

(54) VIRTUALIZED SOFTWARE INTERACTION CONTRACT

(71) Applicant: CA, Inc., (US)

(72) Inventor: Robert Macklin Williams, Howe, TX (US)

(73) Assignee: CA, INC., Islandia, NY (US)

(21) Appl. No.: 13/833,607

(22) Filed: Mar. 15, 2013

(51) Int. Cl. G06F 11/36

(52) U.S. Cl. CPC G06F 11/3684

(57) ABSTRACT

Scenario data is accessed for each of a plurality of scenarios, each scenario corresponding to a respective request by a first software component and a response by a second software component to the respective request. The scenario data of each scenario describes the respective requests and responses included in that scenario. A virtual service that corresponds to the second software component is generated from the scenario data for the plurality of scenarios. A test set that corresponds to the first software component is further generated from the scenario data for the plurality of scenarios

### BACKGROUND

The present disclosure relates in general to the field of computer development, and more specifically, to software development involving coordination of mutually-dependent constrained systems.

Modern software systems often include multiple programs or applications working together to accomplish a task or deliver a result. For instance, a first program can provide a front end with graphical user interfaces with which a user is to interact. The first program can consume services of a second program, including programs served by remote computing systems, in connection with the content or services it provides to the user through the graphical user interfaces, among other examples. In some cases, multiple interoperating programs can be controlled or developed by a single entity, such as a single enterprise, publisher, or developer. In other instances, interoperating programs can be developed and controlled by different parties. In some cases, access to another program can be constrained in connection with the testing or development of the program that is to interoperate with the other program, for instance, when the other program is a live production program and cannot be conveniently brought offline, is owned or controlled by a third party, or is, itself, under development.

### BRIEF SUMMARY

According to one aspect of the present disclosure, scenario data can be accessed for each of a plurality of scenarios, each scenario corresponding to a respective request by a first software component and a response by a second software component to the respective request. The scenario data of each scenario can describe the respective request and the response to the respective request in that scenario. A virtual service that corresponds to the second software component can be generated from the scenario data for the plurality of scenarios. A test set that corresponds to the first software component can be further generated from the scenario data for the plurality of scenarios.

### BRIEF DESCRIPTION OF THE DRAWINGS

FIG. 1 is a simplified schematic diagram of an example computing system including an example virtual service system and an example modeling system in accordance with at least one embodiment;

FIG. 2 is a simplified block diagram of an example computing system including an example virtualization engine and an example model generator in accordance with at least one embodiment;

FIG. 3 is a simplified block diagram illustrating an example service model in accordance with at least one embodiment;

FIG. 4 is a simplified block diagram illustrating aspect of another example service model in accordance with at least one embodiment;

FIG. 5 represent an example request of an example virtual service and an example response by the virtual service to the request in accordance with at least one embodiment;

FIG. 6 is a simplified block diagram illustrating example generation of a test set and virtual service from one or more scenarios in accordance with at least one embodiment;

FIGS. 7A-7E are simplified block diagrams illustrating example actions involving virtualization of a software component in accordance with at least one embodiment; and

FIGS. 8A-8B are simplified flowcharts illustrating example techniques in connection with virtualization of a software component in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

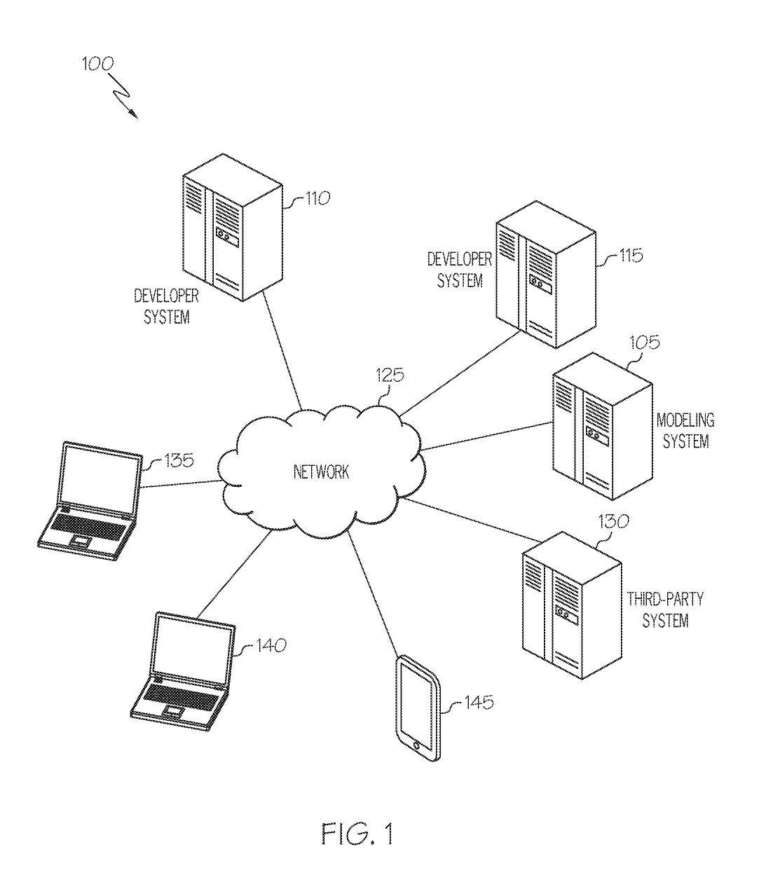

Referring now to FIG. 1, FIG. 1 is a simplified block diagram illustrating an example computing environment 100 including a modeling system 105 and developer systems 110, 115. Developer systems 110, 115 can each be utilized by a development team to develop a respective software component. Such software components can include programs, scripts, objects, applications, modules among other software. In some implementations, the software components developed by a first development team (e.g., using development system 110) may be designed so as to function collaboratively with or be otherwise dependent on another software component, such as a software component developed by a second team or entity (e.g., using development system 115). Further, software components of the second team can likewise be developed to accommodate, be compatible with, or otherwise interoperate with the software components of the first team. Development of software components can include design and development of a software component from the ground up as well as the modification of an existing software component, among other examples.

To assist developers in benchmarking the performance and progress of their respective software components under development, a modeling system 105 can be provided to generate models that simulate the respective behavior and operation of other software components with which the developers' own software is to interoperate and be integrated with. Such models can model software components not readily available for use with another software component upon which the other software component depends. Where the particular software component is not available (or it not desirable to utilize the actual particular software component) a corresponding model can possess or simulate functionality allowing the model to effectively stand-in for the particular software component. Such models can include virtual services configured to generate value- and state-aware responses to requests received from a real world software component (such as a software component under development by development system 110), as well as test sets simulating requests generated by a software component that are to be processed, responded to, or otherwise acted upon by another real world software component (such as a software component under development by development system 115), among other examples.

In some examples, software components, such as applications, to be developed by development systems 110, 115 can be designed to interoperate, communicate, and otherwise integrate over one or more networks 125, including the Internet, private networks, enterprise networks, and so on. Additionally, applications cannot only interface with, consume data from, perform services for, communicate with, and otherwise interoperate with other applications under development, but can also interface and interoperate with still other applications and systems, such as existing third-party systems and services (e.g., 130), such as a social networking server, search engine server, ecommerce server, electronic payment processor, and so on. Further, in some instances, applications (and other software components) can additionally function to provide graphical user interfaces for users to interface with the application using one or more user computing devices (e.g., 135, 140, 145). Further, user computing devices (e.g., 135, 140, 145) can also be used to interface with modeling system 105 and other tools, for instance, to coordinate, edit, and provide further inputs in connection with the generation and maintenance of models simulating operation of one or more software components, including software components under development by development systems 110, 115. For instance, users can edit the models, change assumptions or data relied upon by the models, among other examples.

In general, “servers,” “clients,” “computing devices,” “network elements,” “hosts,” “system-type system entities,” “user devices,” and “systems,” etc. (e.g., 105, 110, 115, 120, 130, 135, 140, 145, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 120, 130, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, a modeling system 105, developer system 110, or other sub-system of computing environment 100 (such as an environment in which models are to be instantiated and run) can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

In some instances, two or more software components, such as an application, program, script, object, or other software components (referred to hereafter sometimes collectively as “application”), are to be developed or modified in parallel by different developers so as to facilitate interoperation of and communication between the applications. In some cases, coordination between the multiple developers can pose a problem as each attempts to coordinate their work with the other developers of downstream (or upstream) applications. For instance, the multiple developers may work to agree on how their respective systems are to interact with the other. Such agreements can sometimes be referred to as a “contract” or “interaction contract” determined between the development teams and describing the ways each application is to interact with the other.

Upon agreeing on an interaction contract, or otherwise on the scope of interactions between the respective applications, the development teams may be theoretically able to work simultaneously to develop their respective applications. However, numerous problems may still arise. The developer of a client application may be unable to test their code and code changes until the server application is completed, delaying integration and completion of the project. Further, there may be no guarantees that both sides adhered to the “contract” or interpreted it in the same way. This can further complicate the integration of the two systems and cause delays, confusion, and contention between the various development teams.

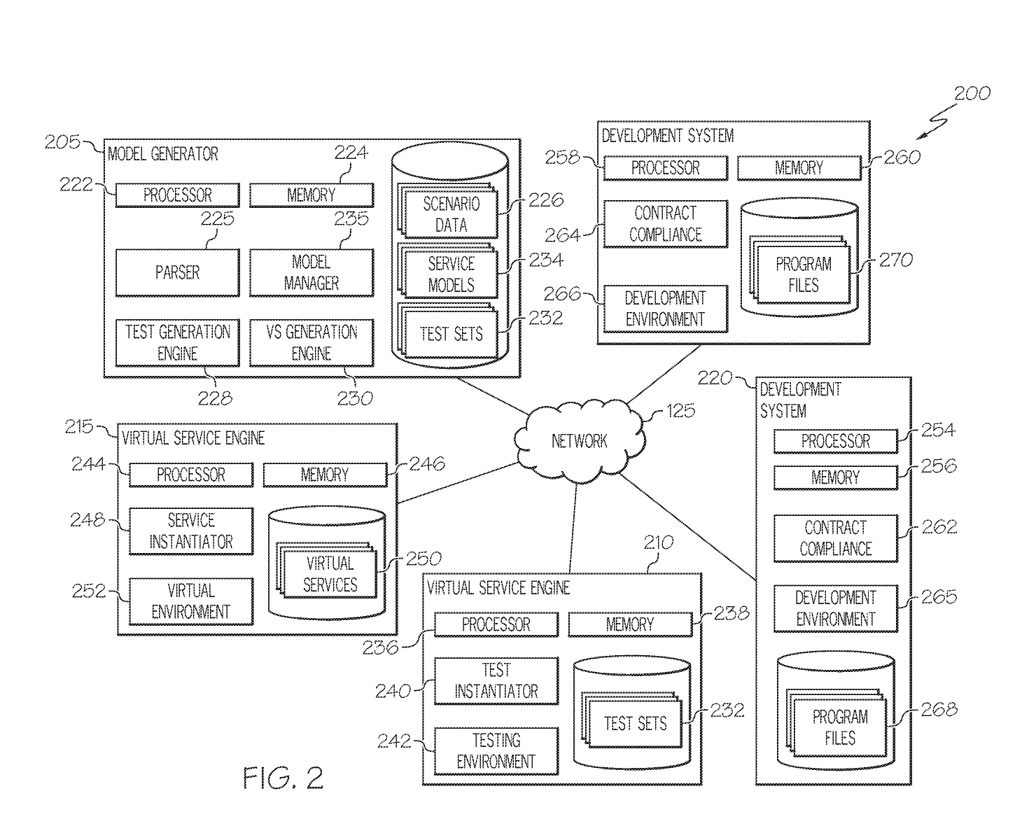

At least some of the systems described in the present disclosure, such as the systems of FIGS. 1 and 2, can include functionality providing at least some of the above-described features that, in some cases, at least partially address at least some of the above-discussed issues, as well as others not explicitly described. For instance, the set of interactions embodying the contract can be used as the basis for defining a set of requests and responses to be exchanged between a client application and a server application. Further, the set of interactions can be described in a format that can be parsed and understood by a computer system (e.g., modeling system 105) and the defined set of interactions can be used to automatically generate (e.g., using modeling system 105) models that simulate operation of the client application for the server application's developer and operation of the server application for the client application's developer, etc. Such models can then be used to “stand in” for the application of the other developer(s), and behave as defined in the interaction contract so as to provide a readily available against which test transactions can be run during development.

Once these models are generated, developers can use the models in development of their respective applications and to test and assess progress of their work against the specifications agreed upon by the parties in the contract. Such tests can be used to confirm that the actual behavior and operation of the developed application conforms to the model embodying the other side's expectations for the application. When both applications are finished and have been verified against the models, the parties can be assured that they have each adhered to the interaction contract, greatly simplifying integration of the applications, among other advantages. For instance, in the event that the interaction contract is to change during (or even after) development, the respective models can be conveniently modified or regenerated to reflect these changes, among other examples.

Systems such as those described in this disclosure can simplify issues arising from such cross-team dependencies and the associated difficulty of integrating their work, among other potential solutions and advantages. As organizations embrace agile software development processes and an iterative approach to development, such systems are further able to facilitate the ability of teams to further work in parallel, and coordinate any subsequent changes in the behavior of their respective systems.

Turning to the example of FIG. 2, a simplified block diagram 200 is shown illustrating an example environment including a model generator 205 adapted to assist in the generation of models that can be deployed to model software components (such as embodied in program files 268, 270) to be developed by one or more developers or development teams. Model generator can also be used in the generation of models of existing software components (e.g., software components not under development). In the example of FIG. 2, a testing engine 210 and virtual service engine 215 can also be provided for use in generating, instantiating, or hosting models configured to simulate operation of various software components. Development systems 220, 225 can also be provided that are adapted for use by developers to develop one or more software components.

In one implementation, an example model generator 205 can include one or more processors 222 and one more memory elements 224 along with other hardware- and software-based components, such as a parser 225, model manager 228, test generation engine 235, virtual service generation 236, among other potential examples including still other functionality, including combinations or portions of the functionality possessed by other modules described herein. In one example, parser 225 can be configured to parse scenario data 226 representing one or more scenarios contemplated in an interaction contract set by partnering or coordinating developers or development teams. Scenario data 226 can describe a set of operational scenarios involving two or more distinct software components each to be controlled by a respective one of the developers. The operation scenarios, or “scenarios,” can describe at least one request or input to be provided by a client application as well as the one or more responses to the request by the server application in a transaction. Indeed, a scenario can encompass multiple transactions in that one response to a request depends on prior requests (e.g., in stateful transactions), among other examples. Further, it should be appreciated that in some implementations of an interaction contract an application may be a “client” or requester in some transactions defined in the contract and may be a “server” or responder in other transactions within the same contract. The parser 225 can therefore determine a set of requests and corresponding set of responses based on parsing of the scenario data 226 together with the format, protocols, operations, and attributes included in each of the requests and responses, among other information, such as performance thresholds.

Through the identification of sets of expected requests and responses corresponding to a set of scenarios defined for interactions between two or more applications, models can be generated. For instance, a test generation engine 228 can utilize data describing the set of expected requests from the scenarios to generate a test set (e.g., 232). The test set can include a substantially exhaustive set of inputs or requests that could be sent from the client application to the server application in accordance with an interaction contract. In some instances, the test set can be stateful and imitate a series of particular requests in a session, such as a session driven by a human user of the client application providing the simulated inputs, among other examples. A virtual service generation engine 230 can likewise use the identified set of expected requests and responses to generate one or more service models 234 to serve as the basis for instantiating a virtual service to simulate operation of the server application in responding as expected to the received the expected requests.

In some implementations, a model generator 205 can be configured to generate models including test sets 232 and service models 234 for a variety of different applications. For instance, model generator 205 can support model generation for any variety of applications, software systems, and software components capable of performing any variety of tasks or services and implemented using potentially any suitable programming language, architecture, and format. A model manager 235 can be provided in some examples to manage access and provisioning of various test sets 232 and service models 234. For instance, some service models may be generated for a particular entity and access to the service model (and corresponding virtual services (e.g., 250)) can be limited to the particular entity. Further, models generated by model generator, such as models generated in connection with a particular interaction contract, can be associated with the particular interaction contract and access and use of the corresponding models can be managed based on a particular entity being a party to the interaction contract, among other examples.

In some implementations, a testing system 210 can be provided in connection with the instantiation of a test set generated and provided by model generator 205. For instance, a testing system 210 can access or store test sets (e.g., 232) and can instantiate, drive, or otherwise use the test sets to model requests being sent by a client application in compliance with a particular interaction contract. In one example, testing system 210 can include one or more processor devices (e.g., 236), one or more memory elements (e.g., 238), among other components including, for example, a test instantiator 240 and testing environment 242. Test instantiator 240 can be used, for instance, to access and provide a particular test set 232 corresponding to an interaction contract within a testing environment 242. The test set 232 can be used by the testing environment to generate requests defined in the test set. Further, test sets 232 can also identify particular conditions to be applied in the requests, including the identification of particular performance characteristics (and corresponding performance data to be used to model particular conditions within client application, among other examples). Accordingly, in such examples, a testing engine 210 can cause such performance data to be selected and utilized in connection with modeling of the corresponding client application, among other examples.

A virtual service engine 215 can be provided to instantiate virtual services from service models 234. For example, a virtual service engine 215 can include one or more processor devices (e.g., 244), one or more memory elements (e.g., 246), among other components including, for example, a virtual service instantiator 248 and virtual environment 252, among other examples. Service models 234 can be accessed that correspond to a particular interaction contract and can be utilized by virtual service engine 215 (using, for instance, a service instantiator 248) to construct a virtual service (e.g., 250) from the service model 234 data. The virtual service 250 can be executed and hosted within a virtual service environment 252, such as a virtual service environment implemented using one or more virtual machines or another environment. In some implementations, functionality of virtual service engine 215 (or testing system 210) can be combined with or included in functionality of the model generator 205. For instance, in some implementations, model generator 205 can both construct service models 234 as well as instantiate virtual services (e.g., 250) from the service models 234, among other potential implementations that may be used in the generation and use of virtual services 350 and test sets 232.

Development systems (e.g., 220, 225) can also be provided and include one or more processor devices (e.g., 254, 258), one or more memory elements (e.g., 256, 260), one or more software components (e.g., program files (e.g., 268, 270), one or more interfaces over which software components can communicate (including over network 125), as well as development environments (e.g., 265, 266) and other tools for use in the development of the software components, among other examples.

In one example, development systems 220, 225 can be additionally equipped with components for using and interfacing with models provided through model generator 205, testing system 210, and virtual service engine 215, etc. For instance, development systems 220, 225 can include a contract compliance engine (e.g., 262, 264) configured to monitor interaction of the development system's 220, 225 corresponding application program files 268 with a model instantiated in testing environment 242 and/or virtual environment 252. A contract compliance engine (e.g., 262, 264) can be used to determine whether the program file's 268 interactions are in compliance with the contract. As an example, program files 268 can correspond to a client application that is to send requests to a server application and receive certain expected responses in response to the requests. The program files 268 may be under development and the progress of the development can be tested against a virtual service (e.g., 250) instantiated in virtual environment 252 and modeling the server application (e.g., developed as program files 270). The contract compliance engine 262 can identify that a particular request sent by the actual program files 268 to the virtual service 250, if implemented correctly, should elicit a corresponding expected response from the virtual service 250 consistent with the interaction contract. Correct operation of the program files 262 can be assessed on the basis of whether the requests generated and sent by the program files 262 elicited the proper response from the virtual service 250, or instead resulted in an unexpected response, an error, or some other result. Similarly, contract compliance engines can monitor responses generated by a program file to requests generated by a test set to determine whether the responses are consistent with the interaction contract. When program files 262, 268 are detected as operating consistent with the interaction contract (e.g., as determined using contract compliance engine 262, 264) developers can be assured that their portion of the contract has been fulfilled and that their software components are ready for integration with the other developer's software components (i.e., provided the other software components are also ready and in compliance with the interaction contract).

In one example, service models (e.g., 234) generated by a model generator 205 can be based on requests and responses between two or more software components or systems (such as application program files 268 and 270). Such request and response information can be derived from scenario data provided in connection with an interaction contract defined between two or more parties. Service models (e.g., 234) can identify each transaction that corresponds to a particular pair or subset of the requests and responses. The service model can further describe characteristics of the transactions. Such information can include timing information identifying time thresholds or limits at which particular requests and/or responses are detected or sent (e.g., in order to identify the delay between when the request was detected and/or sent and when the associated response was detected and/or sent), and the like. Virtual services instantiated from such service models can embody these performance characteristics captured or defined in the service model, including response times, network bandwidth characteristics, processor usage, etc.

In one example, a virtual service generation engine (e.g., 230) can be configured to identify and describe requests and responses in each of a variety of different protocols as well as the pertinent information from each. Thus, service models can include configuration information identifying the basic structure of requests and responses for each of several supported communication protocols. Depending upon the protocol in use, for instance, requests can take the form of method calls to an object, queue and topic-type messages (e.g., such as those used in Java messaging service (JMS)), requests to access one or more web pages or web services, database queries (e.g., to a structured query language (SQL) or Java database connectivity (JDBC) application programming interface (API)), packets or other communications being sent to a network socket, and the like. Similarly, responses can include values generated by invoking a method of an object, responsive messages, web pages, data, state values (e.g., true or false), and the like.

Scenario data (e.g., 226) can further document attributes of requests and responses per the interaction contract. For example, a request can include an operation and one or more attributes. As an example, scenario data can identify a command to perform a login operation as well as attributes that include the user name and password to be used in the login operation, among other potential illustrative examples. Accordingly, model generator 205 can also parse scenario data 226 in order to identify whether and which attributes should be included in requests and responses and generate service models 234 and test sets 232 capable generating responses and requests that incorporate these attributes. Thus, as an example, information identifying a request in a corresponding service model (e.g., 234) can include information identifying a command as well as information identifying any attributes present within a corresponding request.

Service models 234 can be used as the basis of virtual services modeling the software components providing the requests and/or responses modeled in the service models 234. Virtual services can capture and simulate the behavior, data and performance characteristics of complete composite application environments, making them available for development and testing at the request of a user or system and throughout the software lifecycle, among other advantages. In some instances, a model generator 205 can include functionality for the creation of complete software-based environments using test sets and virtual services that simulate observed behaviors, stateful transactions and performance scenarios implemented by one or more software components or applications. Virtual services can provide functionality beyond traditional piecemeal responders or stubs, through logic permitting the recognition of input/requests and generation of outputs/responses that are stateful, aware of time, date, and latency characteristics, support such transaction features as sessions, SSL, authentication, and support string-based and dynamic request/response pairs, among other features. Service virtualization and other virtual models can be leveraged, for instance, when live systems are not available due to project scheduling or access concerns. In cases where components have not been built yet, environments can employ virtual services to rapidly model and simulate at least some of the software components to be tested within an environment. Virtual services can be invoked and executed in a virtual environment (e.g., 252) implemented, for instance, within on-premise computing environments, in private and public cloud-based lab, using virtual machines, traditional operating systems, and other environments, among other examples. In some implementations, model generator 205, service models 234, virtual services (e.g., 250) and other supporting components can utilize or adopt principles described, for example, in U.S. patent application Ser. No. 13/341,650 entitled “Service Modeling and Virtualization,” incorporated herein by reference in its entirety as if completely and fully set forth herein.

In some implementations, when a service model is used to instantiate a virtual service, the virtualization process can involve comparing new requests generated by a requester (e.g., a client application under development) to the request information stored in a corresponding service model. For example, if a new request containing a particular command and attributes is received, the service model can be searched for a matching request that contains the same command and attribute. If a matching request is found, the virtualization process returns the response (as identified by information stored in service model) associated with the matching request to the requester.

In many situations, the requests provided to a virtual service will not be exactly the same (i.e., containing the same request as well as the same attribute(s)) as the requests identified in service model. For example, a request provided to the corresponding virtual service may contain the same request but a different attribute or set of attributes. A service model can further include information usable to handle these requests. For instance, transactions containing requests that specify the same command can be identified as being of the same transaction type. Alternatively, a set of transactions can be identified as being of the same type if all of those transactions have requests that include the same command as well as the same number and type of attributes. The particular technique used to identify whether two or more transactions are of the same type can be protocol specific, in some embodiments (e.g., classification of transactions can be at least partially dependent upon the particular communication protocol being used between the requester and the server).

For each unique type of transaction included in a service model, some implementations of a service model can further provide information or instructions for use by a virtual service in generating responses to requests with unknown attributes (e.g., an unknown attribute that was not observed as part of the monitored traffic or even specified by a user during a manual service model building process). Further, service models can also include information describing how to respond to an unknown request (e.g., a request that contains a command that was not observed as part of the monitored traffic). As an example, the request portion of this service model information can indicate (e.g., through the use of a wildcard command identifier) that all unknown types of requests that are not otherwise identified in service model should match this request. The response portion of the generated information can include an appropriate response, among other examples.

In addition to adding information describing unknown transactions of known and unknown types, some implementations of service models can support time sensitive responses. In such embodiments, response information in the server model can facilitate substitution of time sensitive attributes for actual observed attributes. For instance, an actual attribute “10:59 PM Oct. 1, 2009” can be replaced with a time sensitive value such as “[SYSTEM CLOCK+11 HOURS]”. When the service model is used to generate responses by the virtual service, the time sensitive value can be used to calculate the appropriate attribute to include in each response (e.g., based on the current system clock value). To illustrate, in this particular example, if the service model is being used by a virtual service and the response attribute includes the time sensitive value [SYSTEM CLOCK+11 HOURS], the response generated based upon the service model will include the value generated by adding 11 hours to the system clock value at the time the request was received. In general, time sensitive values specify an observable time, such as a time value included in a request or the current system clock time, and a delta, such as an amount of time to add or subtract from the specified observable time. Time sensitive values can be included in the response information for all types (known and unknown) of transactions.

In some implementations, a service model can further include information facilitating the use of request sensitive values to be included in responses generated by the virtual service using the service model. A request sensitive value can link an attribute included in the request to a value to be included in the response. For example, response information in a service model can indicate that a particular request attribute be used as the basis of a particular attribute of the response to be returned in response to the request.

When the model is used, the response generated by the virtualized service will include the value indicated by the request sensitive value. For example, the model can include three known transactions of a given transaction type, as well as one unknown transaction of that type. The information describing the unknown transaction can indicate that the single response attribute is a request sensitive attribute that should be the same as the first attribute of the request. A request of that type that contains an unknown first attribute (i.e., an attribute that does not match the attribute(s) stored for the three known transactions of that type in the model) can be sent to the virtualized service. In response to receiving this request and accessing the request sensitive value specified in the response information for the unknown transaction, the virtualized service returns a response that includes the value of the first attribute that was contained in the received response. As an example, if the information describing a known transaction of type A indicates that the request includes the string “UserID” as the first request attribute and that the corresponding response includes the string “UserID” as its second response attribute, a request sensitive value specifying “[REQUEST ATT 1]” (first request attribute) can be generated for the second response attribute in the service model, among many other potential examples, including more complex examples with more complex dependencies defined in the service model between certain request attribute and request sensitive response attributes.

A service model can include still additional information. For example, a service model can identify characteristics of each transaction in order to identify availability windows for a corresponding software component modeled by the service model, load patterns for the software component, and the like. For example, if an access window is identified for a particular type of transaction, a corresponding service model can be generated to include a characteristic indicating that a response (or a particular type of response) will only be generated if the request is received during the identified access window, among many other potential examples.

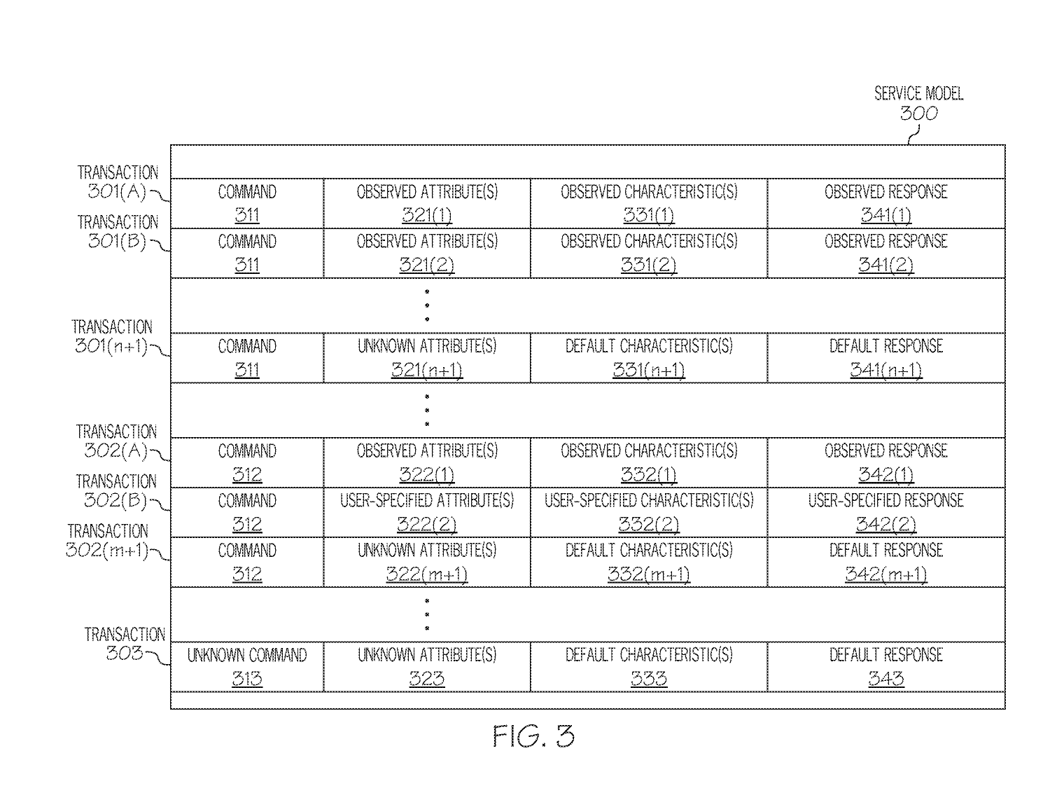

Turning to FIG. 3, a simplified block diagram is shown representing an example view of an example service model 300. For instance, FIG. 3 shows information that can be maintained as part of a service model. In this particular example, service model 300 can include a row for each of several transactions. Each row of service model 300 can identify a command, zero or more attributes, zero or more characteristics, and one or more response attributes. This service model can be stored in a spreadsheet, table, database, or any other data structure.

In this example, transaction 301(A) is a transaction corresponding to a scenario defined in an interaction contract defined between two or more developers. In other instances, transaction 301(A) can be a transaction that was an observed transaction that actually occurred between a requester and a server component being modeled, as detected, for instance, by an agent or other tool. The information describing transaction 301(A) can include request information, which includes command 311 and zero or more defined attributes 321(1). The information describing transaction 301(A) can also include response information 341(1) describing the expected response that corresponds to the request. This response information 341(1) can also include one or more attributes. Characteristics 331(1) can include zero of more characteristics of transaction 301(A) defined based on scenarios of the interaction contract. These characteristics can include timing information describing a threshold delay of a response to a request or the like, as described above.

Transaction 301(B) can be of the same transaction type as transaction 301(A), since both transactions included a request that contained command 311. Transaction 301(B) is described by attributes 321(2) (which can have values that differ from those attributes defined in the request of transaction 301(A)), characteristics 331(2) (which can again differ from those for transaction 301(A)), and response 341(2) (which can also have a value that differs from the response defined for transaction 301(A)).

In this example, information describing n (an integer number) known transactions of the same type as transactions 301(A) and 301(B) is stored in service model 300. These known transactions are transactions that were either generated from scenario data or manually specified by a user. As part of the model building process, information describing an n+1th transaction of the same type has been added to service model 300 by the service model generator. This n+1th transaction, labeled transaction 301(n+1), can describe an “unknown” transaction of a known type of transaction. Such an unknown transactions is of a known type because it has the same command, command 311, as the other transactions of this type. However, unlike the other known transactions of this type, unknown transaction 301(n+1) can be used to respond to requests containing command 311 and “unknown” attributes that do not match those known attributes stored for transactions 301(A)-201(n) (not shown). The information describing transaction 301(n+1) thus includes information (e.g., wildcard information) identifying unknown attributes 321(n+1), such that any request that includes command 311 and an attribute that does not match the defined attributes stored for the actual transactions (e.g., such as transactions 301(A) and 301(B)) will match the request information for transaction 301(n+1). The information describing transaction 321(n+1) can also include default characteristics 331(n+1) and default response 341(n+1). These default values can be copied from the corresponding fields of an actual response of the same type.

Information describing another set of transactions of a different type can also be stored within the service model 300 for a particular software component. As shown, m+1 transactions, including transaction 302(A), 302(B), and 302(m+1) of a type of transaction in which the request includes command 312 can be stored in service model 300. Like transactions 301(A) and 301(B), transaction 302(A) can be another transaction corresponding to a scenario and involving the particular software component. Further, the information describing this transaction can also include the corresponding command 312, attributes 322(1) (if any), defined characteristics 332(1) (if any), and corresponding response 342(1).

In some instances, a model generator can automatically generate a set of requests and responses, together with corresponding attributes and characteristics of the requests and responses based on computer-parsable scenario data provided to the model generator. In some implementations, a user can supplement the transaction defined by the model generator with one or more user-specified transactions, for instance, in the event of a change or exception to the interaction contract or to capture a nuance not adequately detected and captured by the model generator, among other examples. For instance, a user can enter the information describing such a transaction via a user interface. The information describing transaction 302(B) can include command 312, zero or more user-specified attributes 322(2), zero or more user-specified characteristics 332(2), and a user-specified response 342(2). In some embodiments, the user is prompted for entirely new information for each of these user-specified fields. In other embodiments, the user can be allowed to select an existing field (e.g., of another user-specified transaction or of an automatically-detected transaction) to copy into one or more of these fields. It is noted that a user can also create a user-specified transaction by modifying information describing an actual transaction. As FIG. 3 shows, user-supplied transaction information can be stored in the same model as transaction information generated from parsing of scenario data of an interaction contract. In other instances, service models can be generated that are dedicated to user-supplied transaction information while others are dedicated to transaction information generated from scenario data by a model generator, among other examples.

In some instances, a service model 300 can also include information describing an unknown transaction 302(m+1). The information describing transaction 302(m+1) was added to service model 300 after m (an integer number, which does not necessarily have the same value as n) known transactions were described by the model. The information describing this unknown transaction 302(m+1) can be used to handle requests of the same type (e.g., containing command 312) that specify unknown attributes. Accordingly, the information describing transaction 302(m+1) can include command 312, unknown attributes 322(m+1) (i.e., attribute information that will match any attributes not identified in the known attributes stored for the other m transactions of this type), default characteristics 332(m+1), and default response 342(m+1). Further, transactions of an unknown transaction of unknown type (e.g., 303) can also be defined in a service model 300. For instance, the information describing transaction 303 can be used to respond to any request of a type not already described by another row of service model 300. Accordingly, a request containing a command other than commands 311 and 312 could be responded to using the information describing transaction 303, among other examples. As shown, the information describing transaction 303 includes unknown command information 313, which is configured to match any command not already specified in service model 300, unknown attribute information 323, which is configured to match all attributes (if any) associated with unknown commands, default characteristics 333, and a default response 343. As with the default characteristics and responses associated with unknown transactions of known type, transaction 303's default characteristics and response can be user-specified.

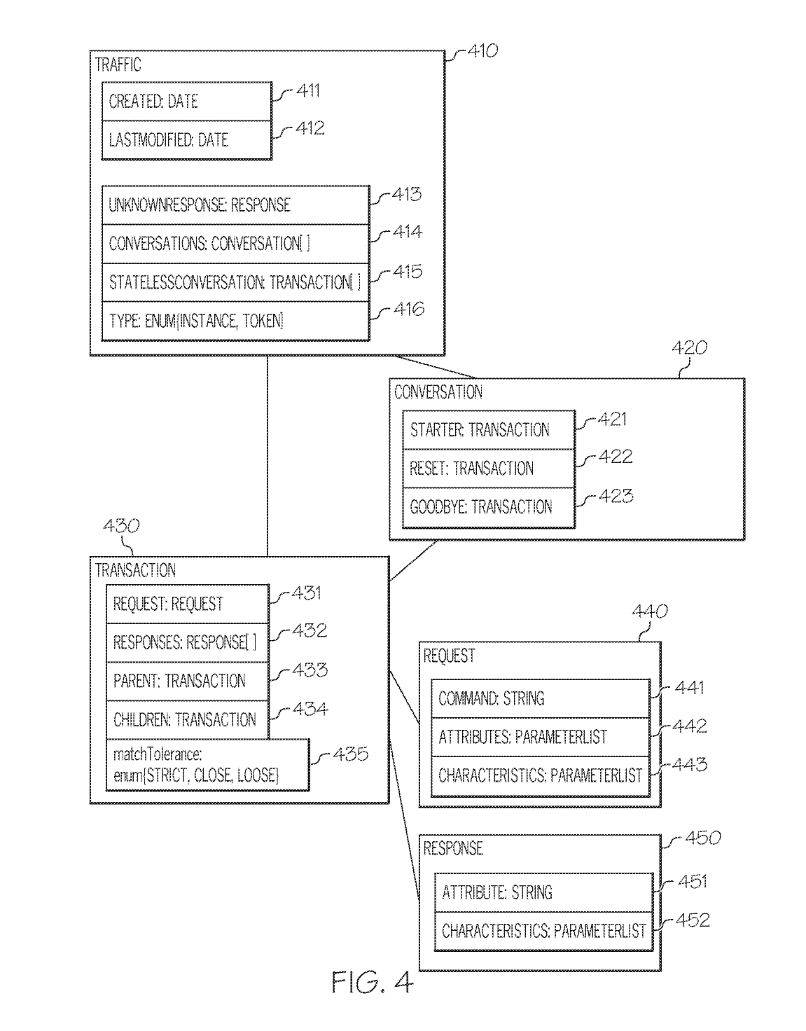

Turning to FIG. 4, a simplified block diagram is shown illustrating representing example features of an example service model for use in virtual services supporting stateful and stateless transactions. Statefulness of a transaction can be identified from parsing of scenario data to generate a service model supporting the modeling of such stateful transactions. In the example of FIG. 4, a data model is shown that includes five data patterns: traffic pattern 410, conversation pattern 420, transaction pattern 430, request pattern 440, and response pattern 450. Traffic pattern 410 can be used to store information identifying a particular software application to be developed in accordance with an interaction contract and the transactions of such an application. Each service model can include a single instance of traffic pattern 410. As shown, traffic pattern 410 includes created field 411, which stores date information identifying when the service model of that particular application was initially created. Traffic pattern 410 also includes lastModified field 412, which stores date information identifying the most recent time at which any of the information in the service model of the particular service was modified.

Traffic pattern 410 can also include an unknownResponse field 413. UnknownResponse field 413 can store information identifying the particular instance of the response pattern that stores information identifying the response to use for unknown transactions of unknown types. Accordingly, in embodiments employing the data pattern of FIG. 4, if an unknown transaction of unknown type is detected by a request processing module, the request processing module will use the response pattern instance identified in unknownResponse field 413 to generate a response.

Traffic pattern 410 includes conversations field 414. Conversations field 414 can identify one or more instances of conversation pattern 420. Conversation pattern 420 stores information representing a set of two or more stateful transactions. Such a set of stateful transactions is referred to herein as a conversation. The instance(s) of conversation pattern 420 identified in conversations field 414 identify all of the conversations for the application to be modeled. If the particular service does not include any stateful transactions (e.g., if no stateful transactions are identified from scenarios defined for an interaction contract), conversations field 414 will not identify any instances of conversation pattern 420.

Traffic pattern 410 can additionally include statelessConversation field 415. This field can identify one or more instances of transaction pattern 430. Transaction pattern 430 stores information representing a transaction. Each instance of transaction pattern 430 identified in statelessConversation field 415 stores information identifying a stateless transaction. StatelessConversation field 415 can identify instances of transaction pattern 430 associated with both known and unknown transactions of known types. If the particular service being modeled does not include any stateless transactions, statelessConversation field 415 will not identify any instances of transaction pattern 430. Type field 416 can store one of two values: INSTANCE or TOKEN that identifies the type of stateful transactions, if any, provided by the service being modeled.

As noted above, conversation pattern 420 can store information identifying a set of stateful transactions. A given service model can include n instances of conversation pattern 420, where n is an integer that is greater than or equal to zero. Conversation pattern 420 can include a starter field 421. This field stores information identifying an instance of transaction pattern 430 associated with a starter transaction. The starter transaction is a transaction that acts as the first transaction in a stateful series of transactions (e.g., a login transaction). In at least some embodiments, all starter transactions can be unknown transactions of known type, as will be described in more detail below. The particular transaction type to use as a starter transaction can be specified by the model generator or a user during the service model configuration process.

Conversation pattern 420 also includes reset field 422. Reset field 422 stores information identifying one or more instances of transaction pattern 430, each of which is associated with a reset transaction (such a reset transaction can be a known or unknown transaction). The value of reset field 422 can be provided by a user (e.g., the user can be prompted to identify the reset transaction(s) for each conversation). A reset transaction is a transaction that, if detected, causes the flow of the conversation to return to the point just after performance of the starter transaction. Conversation pattern 420 also includes a goodbye field 423. This field stores information identifying an instance of transaction pattern 430 associated with one or more goodbye transactions (of known or unknown type) for the conversation. A goodbye transaction is a transaction that causes the conversation to end. To reenter the conversation after a goodbye transaction is performed, the starter transaction for that conversation would need to be reperformed.

Transaction pattern 430 stores information identifying a transaction. Transaction pattern 430 includes request field 431, responses field 432, parent field 433, children field 434, and matchTolerance field 435. Transaction pattern 430 can be used to store stateful and stateless transactions (in some instances, the same transaction can occur both within a conversation and in a stateless situation where no conversation is currently ongoing). Transactions that are always stateless will not include values of parent field 433, children field 434, or matchTolerance field 435.

Request field 431 identifies the instance of request pattern 440 that stores information identifying the request (e.g., by command and attributes) portion of the transaction. Similarly, responses field 432 identifies one or more instances of response pattern 450 that store information identifying the response(s) that are part of that transaction. Each instance of response pattern 450 stores one response attribute (e.g., like those shown in FIG. 2), and thus if responses field 432 identifies multiple response patterns, it indicates that each of the identified response patterns should be used to generate a response when the corresponding request is received.

Parent field 433 stores a value identifying the instance of transaction pattern 430 associated with the transaction that occurs immediately before the current transaction in a conversation. Thus, if transaction pattern 430 stores information identifying the second transaction in a conversation (where the starter transaction is the first transaction in the conversation), parent field 433 can identify the instance of transaction pattern 430 associated with the starter transaction. Similarly, children field 434 can store information identifying each instance of transaction pattern 430 associated with a child transaction of the current transaction. Thus, if transaction pattern 430 stores information identifying the second transaction in a conversation, children field 434 can store information identifying the instance of transaction pattern 430 that stores the third transaction in the conversation. It is noted that children field 434 can identify more than one transaction.

MatchTolerance field 435 can store one of three values: STRICT, CLOSE, or LOOSE. The stored value indicates the match tolerance for a request received immediately subsequent to the current transaction. Strict tolerance indicates, for instance, that, if a conversation is ongoing, the request received immediately after the current transaction is only allowed to match transactions identified in the current transaction's children field 434. If instead close tolerance is specified, the request received immediately after the current transaction can match any of the current transaction's children, as well as any of the current transaction's sibling transactions. Further, if loose tolerance is specified, even more transactions are candidates for matching the next received request, and so on.

Request pattern 440 can include a command field 441, attributes field 442, and characteristics field 443. Each instance of request pattern 440 stores information identifying a particular request. A service model generator can allocate an instance of request pattern 440 for each transaction of known or unknown type. Command field 441 can store a string that identifies the command contained in the request. Attributes field 442 can store a parameter list that includes zero or more parameters, each of which represents an attribute of the request. Characteristics field 443 can store a parameter list identifying zero or more characteristics associated with the request. Each parameter in the list can identify a different characteristic. Examples of characteristics can include the time at which the request was sent, the system clock time at which the request was received by the service being modeled, network and/or system conditions that were present when the request was received, and the like. The parameters stored in characteristics field 443 can be used to generate time sensitive values, as well as to model actual conditions such as response timing and availability window, among other examples.

Response pattern 450 can include an attribute field 451 and a characteristics field 452. Attribute field 451 stores a string that represents a response attribute. As noted above, a given transaction can have multiple response attributes (e.g., responses field 432 of transaction pattern 430 can identify multiple instances of response pattern 450), and thus generating a response can involve accessing multiple response patterns in order to include the string identified in each of the response patterns' attribute field 451 in the response. Attribute field 451 can store one or more response attributes, as well as values, like request sensitive values and time sensitive values, generated by the service model generator. Characteristics field 452 can store a parameter list containing zero or more parameters. Each parameter can identify a characteristic of the response, such as the system clock time when the response was sent to the requester by the service, network and/or system conditions that were present when the response is to be sent, and the like.

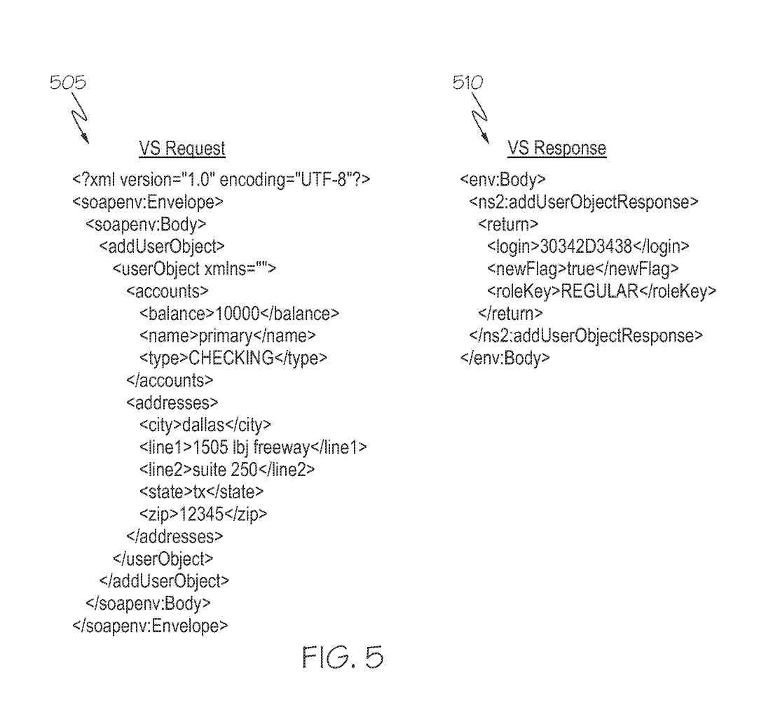

Turning to FIG. 5, a simplified representation of an example request 505 and response 510 are illustrated such as a request 505 that could be provided to a virtual service or generated from a test set and a response 510 that could be generated by a virtual service in response to the request (e.g., 505). For instance, in this particular example, request 505 can be a SOAP request corresponding to a request to open an account, including the designation of various attributes corresponding to the type and amount of the account and personal information to be associated with the account, such as the customer's address, among a variety of other examples. A response to the request can be based at least in part on the operation and attributes of the request 505. In the particular example of FIG. 5, response 510 can confirm the creation of an account, and provide additional confirmation values such as the return of an associated user name, a balance summary, or other examples.

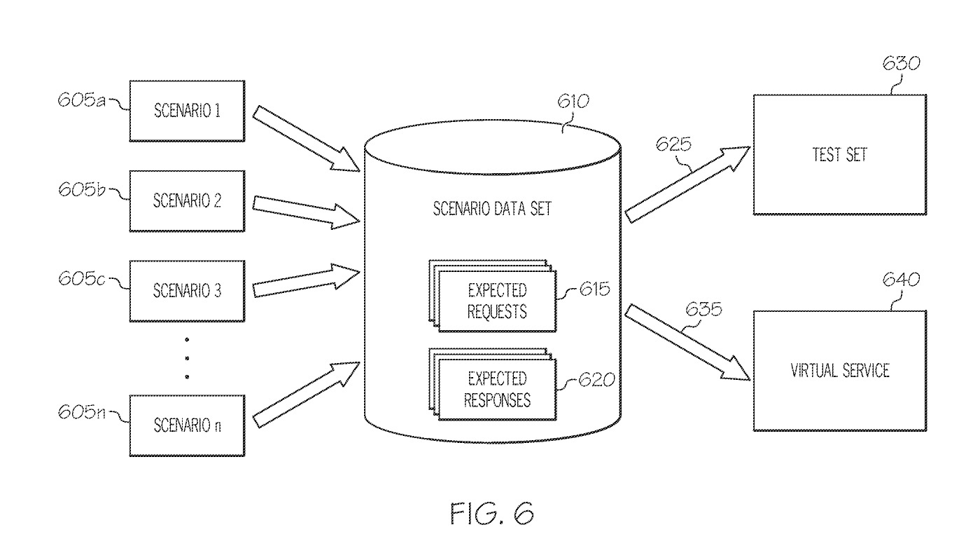

Turning to FIG. 6, a block diagram is shown illustrating an example of models (e.g., 630, 640) being generated from scenario data provided in connection with an interaction between two or more developers. In one example, prior to beginning or progressing too far in the parallel development of two or more software applications that are to be adapted to communicate and interoperate with each other, the respective developers of the two or more applications can determine a substantially exhaustive set of scenarios 605a-n in which the applications are to interact and the behaviors that each application is to perform. The developers can define a substantially exhaustive set of scenarios describing each of the variety of types of requests or inputs one application is to send to another and further describing the type and form of the response that is to be returned to each respective request, for instance, based on the operation and attributes (or type) of the request. Further, the scenarios can indicate how the responses are to reflect the state of particular transaction (e.g., a request and its response), performance conditions of the transaction, as well as other characteristics of the transaction.

A set of scenarios 605a-n can be defined including corresponding scenario data describing the interactions. Scenario data can be human readable descriptions of the interactions. Scenario data can specify the various expected interactions in a variety of ways, such as through scenario data implemented as sets of tables, structured text, or sets of text files (e.g., a text file, a pcap file, an XML file, or an idoc file) with a naming convention indicating the association of a response with a request, attributes of the requests and responses, performance characteristics or thresholds for the transaction, etc. Scenario data can be computer parsable data that can be processed to identify associations between particular requests and responses, their respective characteristics, operations, and attributes, performance characteristics, statefulness (or statelessness), etc. The scenario data can be provided as set of scenario data 610 describing the collection of scenarios (e.g., 605a-n) included in an interaction contract. A model generator can parse or otherwise interpret the scenario data 610 to identify and define a set of expected requests 615 and expected responses 620 corresponding to the interactions described in scenario data 610. From the expected requests a set of test sets 630 can be generated 625, each test set adapted to generate at least a portion of the requests 615 that could be expected of a client application in compliance with the terms of the interaction contract. Responses 620 can also be considered in the generation 625 of test set 630, for instance, to provide test 630 with additional logic for identifying the expected type and form of a compliant response to a request generated by the test set. Such information can be used, for instance, by a contract compliance engine to assess compliance of a server application's responses to a particular simulated request of a test set 630, among other examples.

Expected requests 615 and expected responses 620 defined from a scenario data set 610 can be used to generate 635 service models, such as those incorporating one or more of the features described above, that can be used to instantiate a virtual service 640 within a virtual environment. The virtual service 640 can stand-in for the server application and generate context-appropriate responses to requests of a client application under development. It can be assumed that the virtual services (and test sets) generated from a set of scenarios (e.g., 605a-n) perform in perfect compliance with an interaction contract and, as a result, if problems arise during a simulation involving an application under development interacting with the virtual service, it can be assumed that the problems stem from the application not being in compliance with the interaction contract (i.e., and not the virtual service based from the contract terms itself). If it is discovered that the application is, in fact, operating as expected, inconsistencies or errors in a virtual service or test set can be uncovered and based, for instance, on insufficiently detailed or incorrect scenario data. Scenario data can then be edited by users to refine the defined interactions of the interaction contract or even to add or delete interactions. The virtual services and test sets can then be regenerated from the edited scenario data, in some cases, in real time, to reflect the changes made to the scenario data.

Multiple test sets (e.g., 630) and virtual services (e.g., 640) can be generated to model the complete set of scenarios (e.g., 605a-n) defined under an interaction contract between two or more developers. The set of test sets and virtual services can represent the contract itself and be used as the basis for determining each developer's respective compliance with the terms of the interaction contract.

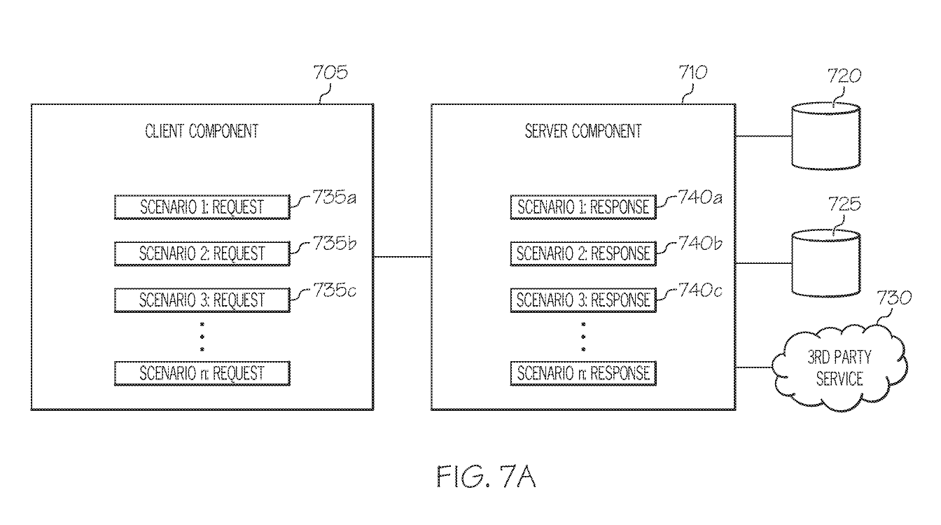

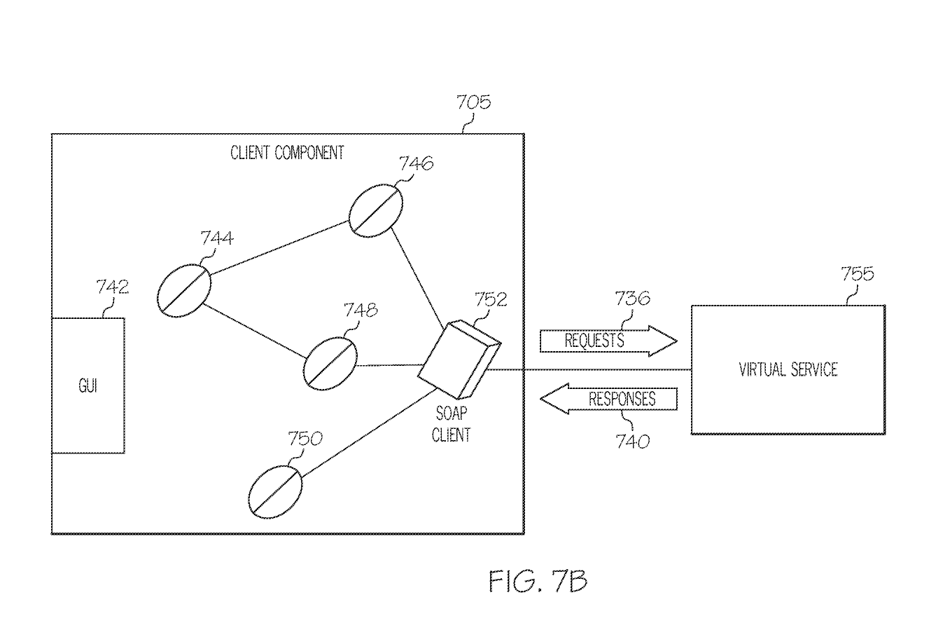

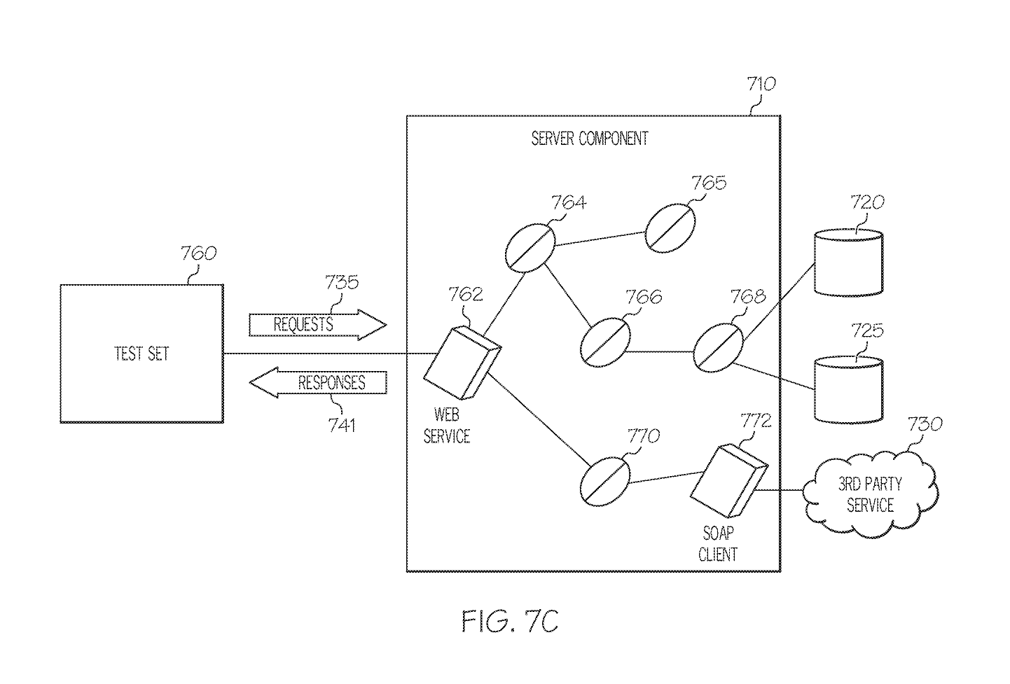

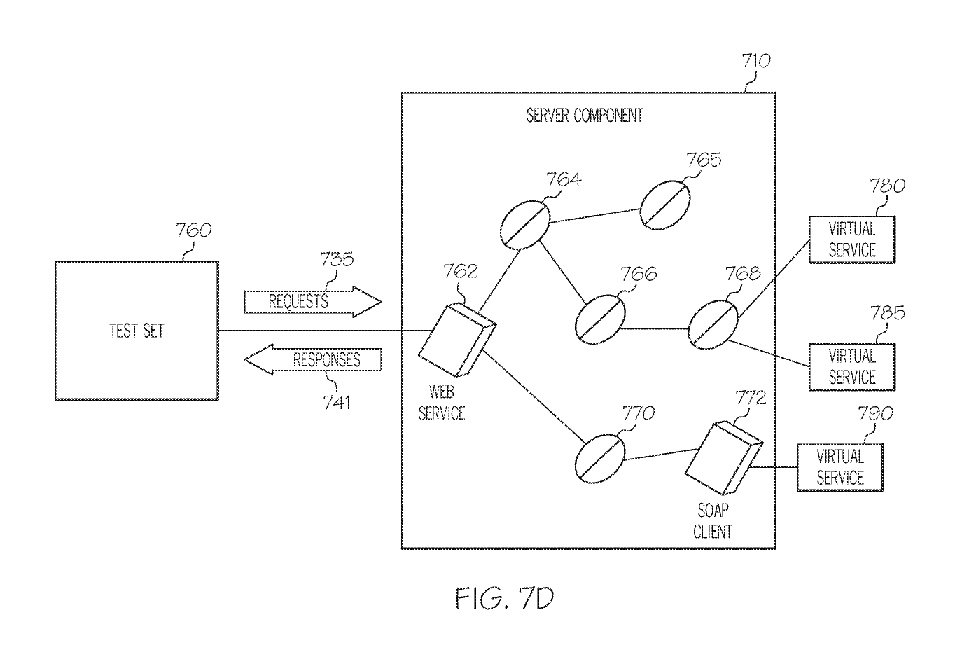

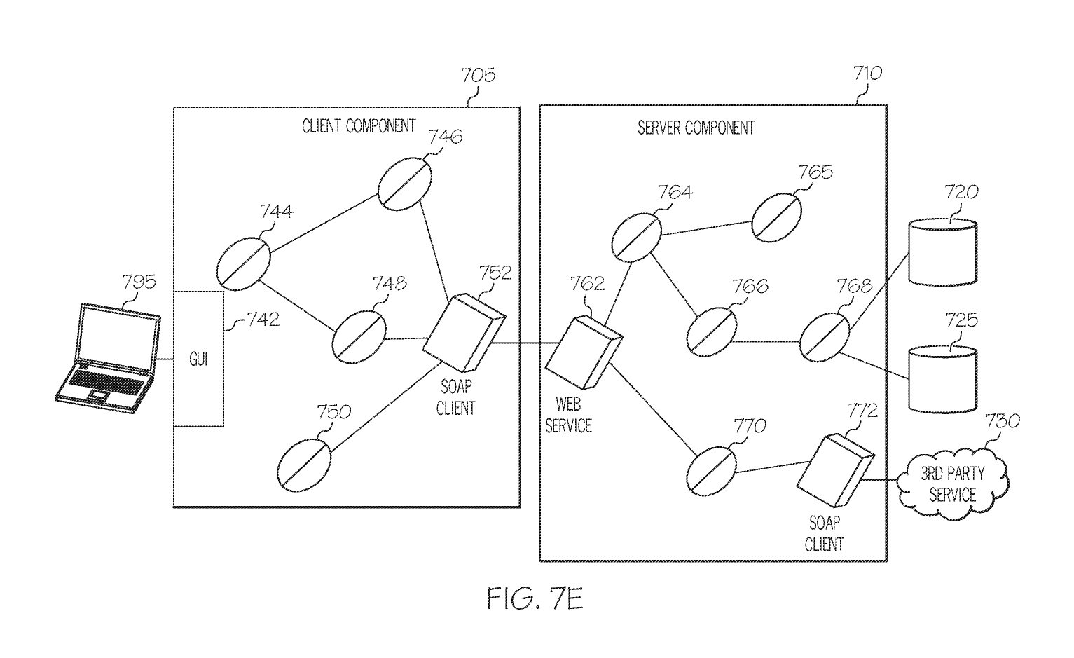

Turning to the examples of FIGS. 7A-7E, in FIG. 7A a simplified block diagram is shown illustrating a conceptual design of one example of a client software component and server software component. Again, it should be noted, that in some instances an application or other software component can be both a “client” and a “server” in that the software component acts as the “client” or requester in less than all of the transactions to be defined between two software components (e.g., 705, 710), and can be the “server” in other transactions. In other instances, a software component may be the client or the server in all transaction with another software component, among other examples. In the examples of FIGS. 7A-7E, as shown in FIG. 7A, an interaction contract can specify that a first software component 705 be configured to provide a set of requests (e.g., 735a-c) to a second software component 710 in connection with the interactions or scenarios defined under the interaction contract. Correspondingly, the interaction contract can specify that server software component 710 should be configured to generate a particular set of responses (e.g., 740a-c) to the defined requests (e.g., 735a-c).

Each of the software components 705, 710 can interface with other software components and services, including those that exist as well as others under development. For instance, in the particular example of FIG. 7A, software component 710 can act as a responder in transactions with client software component 705 but act as the client, or requester, in transactions with other software components and resources, such as databases 720, 725 and existing third-party service 730, among other examples. Software component 710 can consume data from databases 720, 725 and existing third-party service 730, for instance, in connection with generating responses 740a-c to requests 735a-c. Further, in some implementations, additional virtual services can be generated for developers of software component 710 to simulate operations of databases 720, 725 and existing third-party service 730. Virtual services modeling existing software component can be generated, in some instances, from observed transactions involving the software component (e.g., databases 720, 725 and existing third-party service 730), among other examples.

Turning to FIG. 7B, as discussed above, scenario data describing a set of interactions (e.g., including requests 735a-c and responses 740a-c) can be used to generate respective models of software components 705, 710. Software components 705, 710 may both be under development and, thus, unavailable for use in direct integration testing by the other developer. In traditional development systems, developers on one side of a transaction wait until the software component(s) on the other side of the transaction are completed, potentially delaying refinements and integration testing of the other software components, among other issues.

As shown in the example of FIG. 7B, a virtual service 755 can be instantiated that is configured to model operation of software component 710. As the various sub-components (e.g., 742, 744, 746, 748, 750, 752) of client software component 705 are developed to realize the expected functionality of the software component 705, the software component 705 can be run and tested in its current developmental state against the virtual service 755 modeling a contract-compliant software component (e.g., component 710). One or more requests 736 that are to comply with expected requests (e.g., 735a-c) defined in the interaction contract can be sent to the virtual service 755 and the virtual service 755 can generate responses 740 per the interaction contract's definitions. Where it is determined that requests 736 elicit the same responses (e.g., 740) that would be realized from expected requests (e.g., 735a-c), developers can conclude that the software component 705 is operating, at least with regard to requests 736, in a manner consistent with the interaction contract.

Similarly, turning to FIG. 7C, a developer of software component 710 can develop the constituent elements and sub-components (e.g., 762, 764, 765, 766, 768, 770, 772, etc.) of the software component 710 so as to realize the functionality expected of the software component 710 under the interaction contract. Software component 710 can be tested for compliance with the interaction contract by testing the software component's 710 responses (e.g., 741) to modeled requests 735 generated by a test set 760 modeling software component 705 developed in parallel with software component 710. If the software component 710 generates responses 741 consistent with those (e.g., 740a-c) defined under the interaction contract, the developer of software component 710 can conclude that the software component 710 is operating correctly. Further, testing of a software component 710 can include the use of external software components, resources, and services (e.g., 720, 725, 730, etc.), to ensure that the software component 710 is correctly using the external components (e.g., 720, 725, 730, etc.) to generate interaction contract-compliant responses 741.

In some instances, testing of software component 710 for compliance with an interaction contract involving software components 705, 710 can be complicated by the constrained availability of external components (e.g., 720, 725, 730, etc.) for the test. Indeed, in some instances, software component 710 may be dependent on live components (e.g., 720, 725, 730, etc.) that may not be available for use in a particular test or development context. Accordingly, in one example illustrated in FIG. 7D, software component 710 can utilize instantiations of virtual services 780, 785, 790 modeling external components 720, 725, 730 to provide software component 710 with modeled responses of software components 720, 725, 730 used by the software component 710 in generating responses to requests of software component. Thus, virtual services 780, 785, 790 can be used to facilitate testing of software component 710 in generating responses 741 based on data obtained from the external components 720, 725, 730, among other examples or arrangements.

Turning to FIG. 7E, when each of the developers party to an interaction contract have tested their respective software components against corresponding test sets and virtual services modeling the software components of the other developer and conclude that their own software components are in full compliance with the interaction contract, the parties can mutually verify their compliance with their interaction contract. For instance, a contract compliance engine can be used to identify compliance of a software component with one or more scenarios through a test of the software component against test sets and virtual services generated for the interaction contract. The contract compliance engine can be used to generate data identifying compliance of the software component with some or all of the scenarios defined under the interaction contract. Such data can be used to certify compliance of the software component with the interaction contract. When both developers certify compliance of their respective software components, the software components (e.g., 705, 710) can be integrated and allowed to interoperate within further test or live operational environments (e.g., including tests involving live customer devices (e.g., 795) initiating real world transactions, among other examples).

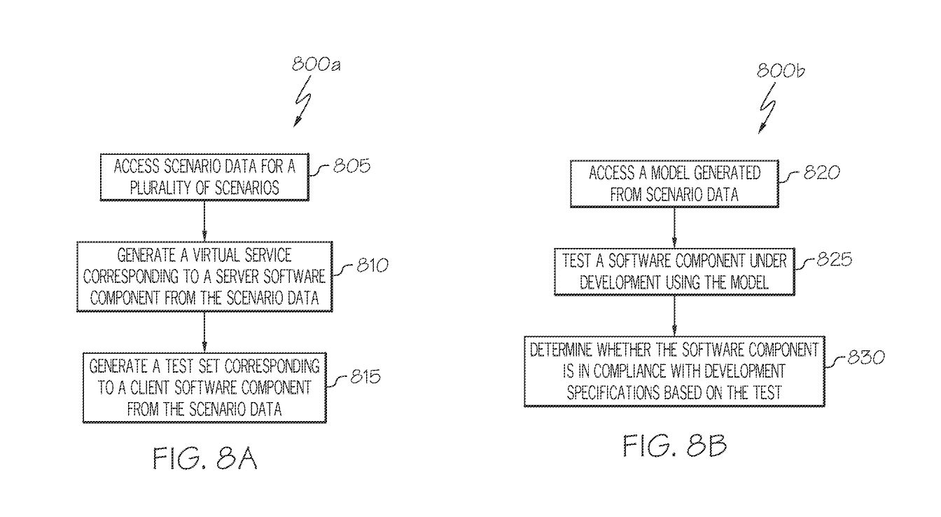

FIG. 8A is a simplified flowchart 800a illustrating an example technique for generating a set of one or more virtual services and a set of one or more test sets to model expected functionality of software components defined in scenario data. For instance, scenario data can be accessed 805 for a plurality of scenarios describing how a first software component is to interact with a second software component. The scenario data can be interpreted to identify or define transactions between the first and second software components, each transaction including a request by one of the software components and a corresponding response to the request by the other software component. In each transaction, the requesting software component can be considered the client software component and the responding software component can be considered the server software component. One or more virtual services can be generated from the scenario data for the server software component(s). The virtual service can be generated 810, for example, based on transaction data describing a request and its corresponding response. Further, one or more test sets can be generated 815 for the client software component of one or more transactions identified in the scenarios. Test sets, in some examples, can be generated 815 based on requests identified from the scenario data. In some implementations, a single virtual service can be generated 810 to model the functionality of the software component in generating the complete set of responses expected to be generated by a particular software component in accordance with an interaction contract. Similarly, a single test set can be generated for a particular software component to model the complete set of request types that the particular software component is expected to generate in accordance with an interaction contract.

FIG. 8B is a simplified flowchart 800b illustrating an example technique for using models generated from scenario data, such as virtual services and test sets. For instance, such a model can be accessed 820. Where a responding software component is to be modeled a corresponding virtual service can be identified and accessed 820. Where a requesting software component is to be modeled, a corresponding test set can be identified and accessed 820. The model can be instantiated in an environment capable driving execution of the model and a software component can be tested 825 against the model. For instance, a software component under development can utilize the model as a stand-in for transactions involving the software component and a corresponding other software component modeled by the model. Further, using the test, it can be determined 830 whether the software component under test is in compliance with specifications for the software component (such as defined in an interaction contract), based on an analysis of how the software component performed when interacting with the model.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
accessing, using a processor device, scenario data for each of a plurality of scenarios defined for intended interactions of a first software component and a second software component, wherein each scenario corresponds to a respective request by the first software component and a response by the second software component to the respective request and the scenario data of each scenario describes the respective request and the response to the respective request;
generating a virtual service corresponding to the second software component from the scenario data for the plurality of scenarios, wherein the virtual service is to interact with the first software component and simulate responses of the second software component to requests of the first software component; and
generating a test set corresponding to the first software component from the scenario data for the plurality of scenarios, wherein the test set is to send requests to the second software component to simulate requests by the first software component in the interactions.

2. The method of claim 1, wherein both the first software component and second software component are under development.

3. The method of claim 1, wherein the virtual service is to model the second software component.

4. (canceled)

5. The method of claim 3, wherein the virtual service is to recognize statefulness of a transaction involving the first software component and at least some of the simulated responses are based on a recognized state of the transaction.

6. The method of claim 3, wherein the virtual service is to model performance characteristics of the second software.

7. The method of claim 3, wherein the simulated responses the virtual service is to recognize attribute values of the requests of the first software component and generate the simulated responses based on the recognized attribute values.

8. The method of claim 1, wherein the test set models the first software component.

9. The method of claim 8, wherein each request comprises an operation and an attribute.

10. The method of claim 8, wherein the test set models all request types to be generated by the first software component to the second software component within the intended interactions.

11. The method of claim 10, wherein the virtual service is to model responses of the second software component to at least each of the request types modeled by the test set.

12. The method of claim 1, further comprising parsing scenario data to identify a set of potential requests by the first software component to the second software component and identify a set of responses by the second software component to each of the set of potential requests.

13. The method of claim 12, wherein the scenario data comprises one of a set comprising a text file, a pcap file, an XML file, and an idoc file.

14. The method of claim 1, further comprising providing the virtual service for use in a development system to verify correct operation of the first software component.

15. The method of claim 1, further comprising providing the test set for use in a development system to verify correct operation of the second software component.

16. The method of claim 1, wherein the virtual service and test set represent an interaction contract between a developer of the first software component and developer of the second software component.

17. The method of claim 16, wherein the scenarios are to represent expectations of each developer with respect to interoperation of the first software component with the second software component.

18. The method of claim 1, further comprising receiving a request to modify the scenario data corresponding to a change to the plurality of scenarios.

19. The method of claim 18, further comprising automatically modifying the virtual service based on modification of the scenario data.

20. The method of claim 18, further comprising automatically modifying the test set based on modification of the scenario data.

21. A computer program product comprising a non-transitory computer readable storage medium comprising computer readable program code embodied therewith, the computer readable program code comprising:
computer readable program code configured to access scenario data for each of a plurality of scenarios defined for intended interactions of a first software component and a second software component, wherein each scenario corresponds to a respective request by the first software component and a response by the second software component to the respective request and the scenario data of each scenario describes the respective request and the response to the respective request;
computer readable program code configured to generate a virtual service corresponding to the second software component from the scenario data for the plurality of scenarios, wherein the virtual service is to interact with the first software component and simulate responses of the second software component to requests of the first software component; and
computer readable program code configured to generate a test set corresponding to the first software component from the scenario data for the plurality of scenarios, wherein the test set is to send requests to the second software component to simulate requests by the first software component in the interactions.

22. A system comprising:
a processor device;
a memory element; and
a model generation engine to:
access scenario data for each of a plurality of scenarios defined for intended interactions of a first software component and a second software component, wherein each scenario corresponds to a respective request by the first software component and a response by the second software component to the respective request and the scenario data of each scenario describes the respective request and the response to the respective request;
generate a virtual service corresponding to the second software component from the scenario data for the plurality of scenarios, wherein the virtual service is to interact with the first software component and simulate responses of the second software component to requests of the first software component; and
generate a test set corresponding to the first software component from the scenario data for the plurality of scenarios, wherein the test set is to send requests to the second software component to simulate requests by the first software component in the interactions.

23. The system of claim 22 comprising a compliance engine to:
instantiate the virtual service;
direct a particular request of the first software component to the virtual service, wherein the virtual service is to generate a particular simulated response of the second software component to the request; and
verify correct operation of the first software component based at least in part on whether the particular response comprises an expected response to the particular request.

24. The system of claim 23, wherein the compliance engine is further to:
instantiate the test set;
direct a particular request generated by the test set and modeling a request of the first software component to the second software component, wherein the second software component is to generate a particular response to the generated particular request; and
verify correct operation of the second software component based at least in part on whether the particular response comprises an expected response to the generated particular request.
